(19) United States
(12) Patent Application Publication
(10) Pub. No.: US 2020/0192481 A1
(43) Pub. Date: Jun. 18, 2020

(54) INTERACTIVE DEVICE HAVING A MODIFIABLE STRUCTURE

(71) Applicant: IMMERSION CORPORATION, San Jose, CA (US)

(72) Inventor: Vahid KHOSHKAVA, Montreal (CA)

(21) Appl. No.: 16/224,615

(22) Filed: Dec. 18, 2018

(51) Int. Cl. G06F 3/01; G06F 3/03; G01L 1/20

(52) U.S. Cl. CPC G06F 3/016; G01L 1/20; G06F 3/03

(57) ABSTRACT

Interactive devices configured for producing haptic effects through structural modification are provided. The interactive devices include a modifiable structure configured with one or more actuators to generate internal forces within the modifiable structure. The generated internal forces provide haptic effects to a user through the modifiable structure, including expansion and compression effects, resistance and assistance effects, vibration effects, and kinesthetic effects. The interactive devices are further configured to receive user inputs applied to the interactive device through tensile or compressive forces.

### FIELD OF THE INVENTION

The present invention relates to an interactive device having a modifiable structure. In particular, embodiments hereof are directed to devices and methods of using a modifiable structure of an interactive device to provide haptic effects and receive user inputs.

### BACKGROUND OF THE INVENTION

Increasingly, computer systems, including immersive reality systems, present output to a user through multiple modalities, including visual, audible, haptic, and kinesthetic outputs. Such computer systems may also allow user input through non-conventional modalities that extend beyond traditional mice and gaming controllers. As computer systems evolve, methods and devices for interacting with them may evolve as well.

The inventions described herein provide methods and devices for user interactivity wherein the user inputs are received and haptic outputs are provided based on structural modifications of an interactive device.

### BRIEF SUMMARY OF THE INVENTION

In an embodiment, an interactive device is provided. The interactive device includes a modifiable structure configured for structural modification in response to an activation control signal. The modifiable structure includes a pair of bridge elements, wherein the pair of bridge elements extends between a pair of hinge elements, and a pair of actuators disposed on the pair of bridge elements. The interactive device further includes a circuit configured to deliver an activation control signal to the pair of actuators. The pair of actuators generates a force between the pair of bridge elements in response to the activation control signal, the force causing the modifiable structure to output a haptic effect.

In another embodiment, a method of modifying the structure of an interactive device to produce a haptic effect is provided. The method includes providing an activation control signal to a pair of actuators disposed on a pair of bridge elements of a modifiable structure of the interactive device, wherein the bridge elements extend between a pair of hinge elements; generating a force between the pair of bridge elements by the pair of actuators in response to the activation control signal, and outputting a haptic effect based on the force.

### BRIEF DESCRIPTION OF THE DRAWINGS

The foregoing and other features and advantages of the invention will be apparent from the following description of embodiments hereof as illustrated in the accompanying drawings. The accompanying drawings, which are incorporated herein and form a part of the specification, further serve to explain the principles of the invention and to enable a person skilled in the pertinent art to make and use the invention. The drawings are not to scale.

FIG. 1 is a schematic drawing of a system configured for haptic effects provided through structural modification of an interactive device.

FIGS. 2A-2D illustrate aspects of a modifiable structure of an interactive device configured to provide haptic effects based on structural modification.

FIGS. 3A-3D illustrate aspects of a modifiable structure of an interactive device configured to provide haptic effects based on structural modification.

FIGS. 4A-B illustrate aspects of a modifiable structure of an interactive device configured to provide haptic effects based on structural modification.

FIG. 5 illustrates a user device incorporating an interactive device configured to provide haptic effects based on structural modification.

FIG. 6 illustrates a user display device incorporating an interactive device configured to provide haptic effects based on structural modification.

FIG. 7 illustrates an interactive device configured to provide haptic effects, based on structural modification, in use in an immersive reality system.

FIG. 8 illustrates a process of providing haptic effects via structural modification of an interactive device.

### DETAILED DESCRIPTION OF THE INVENTION

Specific embodiments of the present invention are now described with reference to the figures. The following detailed description is merely exemplary in nature and is not intended to limit the invention or the application and uses of the invention. Furthermore, there is no intention to be bound by any expressed or implied theory presented in the preceding technical field, background, brief summary or the following detailed description.

Structures and interactive devices as described herein are configured to provide haptic effects through actuator driven structural modifications and to receive input according to pressure or force applied by a user. Actuators incorporated into the internal structures of interactive devices are activated to generate tensile, compressive, and shear forces within, or interiorly to, the internal structure. The generated forces are employed to provide haptic effects to a user, in the form of changes in size and shape of the internal structure, resistance or assistance to user force, vibration haptic effects, and/or kinesthetic haptic effects. Users provide input to the interactive devices as described herein by pulling or pressing on the interactive devices, thereby creating tensile or compressive forces on the internal structure. These user-generated forces may alter the size of the internal structure and/or may be resisted by forces generated by the actuators of the internal structure. In the hand or hands of a user, an interactive device consistent with embodiments hereof, provides a unique set of haptic effects originating from internal structural changes of the device.

Embodiments of the present invention may incorporate immersive reality environments involving mixed visual and haptic effects. Immersive reality, as used herein, describes visual display systems that provide altered reality viewing to a user. Immersive reality environments include virtual reality environments, augmented reality environments, mixed reality environments, and merged reality environments, as well as other similar visual environments. Immersive reality environments are designed to provide visual display environments that mimic a realistic viewing experience and include panoramic imaging where a user's movements determine the display. As a user turns their head or body, the images displayed to the user are adjusted as if the user were inside the immersive reality environment. Immersive reality environments frequently include stereoscopic or other three-dimensional imaging technologies to improve realism. Immersive reality environments may include any mix of real and virtual objects that may or may not interact with one another.

Embodiments of the present invention include modifiable structures. Modifiable structures consistent with embodiments hereof are smart structures configured to have internal forces controlled via external means to adjust the apparent stiffness and/or the shape change of the modifiable structures. Modifiable structures include an internal microstructure configured to respond to external force through a combination of deformation and movement of the component parts of the microstructure. Deformation of some components, referred to herein as hinge elements, permits the movement of other components, referred to herein as bridge elements. Actuators disposed on the bridge elements are configured to generate forces that cause or resist movement of the bridge elements with respect to one another. The movement is facilitated by deformation of the hinge elements. Movement of the bridge elements causes changes in the size and shape of the modifiable structure. Actuator forces that prevent movement of the bridge elements cause an increase in the apparent stiffness of the modifiable structure. A user can interact with the modifiable structure by pulling, stretching, shearing or otherwise applying force. The applied force can be resisted or assisted by the forces of the actuators disposed on the moveable bridge elements.

In an embodiment, the modifiable structure may have a cellular microstructure. A user may stretch the modifiable structure having the cellular microstructure, and the cells of the microstructure expand or open when the user applies force. Using actuators that employ electrostatic adhesive force, the expansion of the cells can be resisted, requiring a large force from the user to stretch the modifiable structure. In this example, the cells are aligned vertically to the applied force and cells are non-connected, similar to a closed cell foam. In another embodiment, the cells of a microstructure are arranged such that compression of the microstructure causes the cells to open and can be resisted by actuators providing an electrostatic adhesive effect.

Further modifiable structures may be employed according to the principles discussed herein. Modifiable structures consistent with embodiments hereof include porous, cellular, or lattice-like microstructures with thin actuation systems incorporated therein. The microstructures include structures having parts or elements, such as the above described bridge elements, in close proximity to one another. External forces applied to the microstructures cause the bridge elements to move apart from or closer to each other. Enabling this movement are parts in the microstructure that act as hinges, such as the above described hinge elements, that permit the bridge elements to move with respect to each other. Further, internal forces are generated within these structures through the placement of actuators that cause the bridge elements to move towards or away from each other or resist movements of the bridge elements towards or away from each other. Structures consistent with embodiments hereof include any type of structure having parts that move when loading is applied. The structural material may include any type of soft or rigid materials in any combination. For example, a modifiable structure may be constructed of metal, plastic, paper, cardboard, carbon fiber, and any other suitable material.

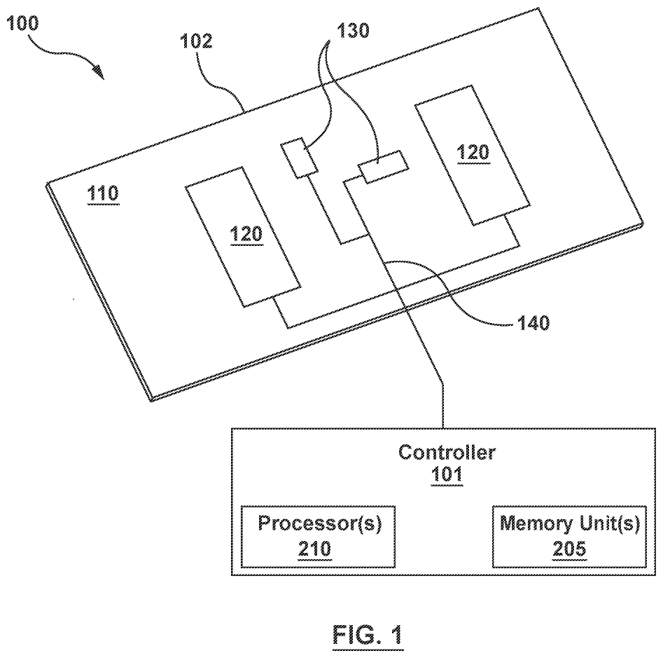

FIG. 1 is a schematic drawing of a system for structural modification of an interactive device. The system 100 includes at least a controller 101 and an interactive device 102. The interactive device 102 includes a modifiable structure 110 having one or more actuators 120, one or more sensors 130, and one or more circuits 140. In embodiments, the interactive device 102 may include additional or fewer components than those described above, as discussed in greater detail below.

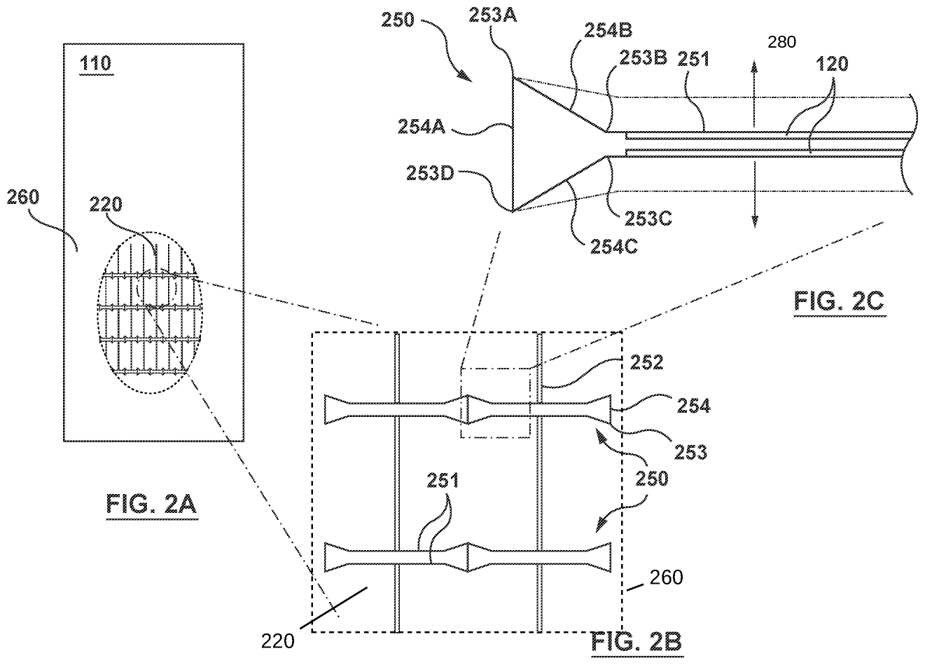

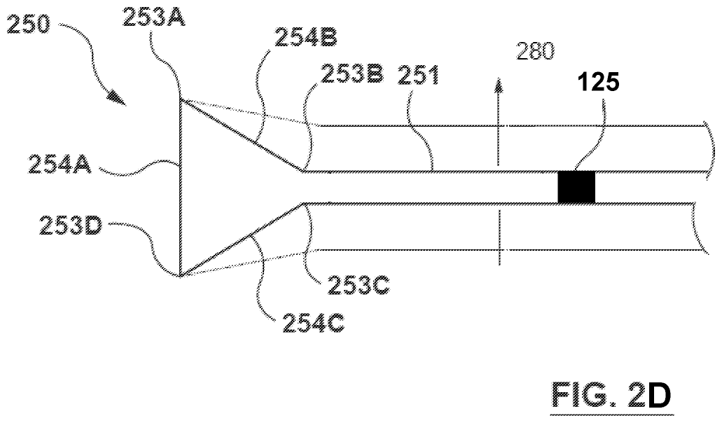

The modifiable structure 110 is a structure capable of structural modification or shape change. Such modification or shape change may be caused by the actuators 120 of the modifiable structure 110 in response to an activation control signal delivered by the one or more circuits 140. The activation control signal causes the actuators 120 of the modifiable structure 110 to generate internal compressive or tensile forces, as explained in greater detail below. Such forces may cause the modifiable structure 110 to change shape by compressing or expanding longitudinally. When the actuators 120 are modulated by a varying activation control signal, as discussed in greater detail below, the internal forces may also cause an increase or decrease in the apparent stiffness of the modifiable structure 110. As used herein, “apparent stiffness” refers to the feeling of stiffness as experienced by a user. If a user presses on the modifiable structure 110 and internal forces are generated to resist the user's pressure, the modifiable structure 110 will feel stiffer to the user, even though the increased resistance is due to a generated force and not a material property. Modulated properly, the internal forces generated by the actuators 120 of the modifiable structure 110 may provide changes in apparent stiffness that are indistinguishable to a user from changes in material stiffness. The active response of the modifiable structure 110 is enabled by an internal microstructure, as illustrated and explained in greater detail with respect to FIGS. 2A-2D.

The modifiable structure 110 may be constructed with any dimensions suitable for use in an interactive device. In an embodiment, the modifiable structure 110 is substantially flat and has a depth dimension significantly smaller than its length dimension and its width dimension. The modifiable structure 110 may be rectangular, square, oval, elliptical, trapezoidal, or any other shape suitable for the uses described herein. In embodiments, the modifiable structure 110 is generally rectangular with rounded corners.

The modifiable structure 110 is incorporated into the interactive device 102 such that expansion or contraction of the modifiable structure 110 may be felt by a user of the interactive device 102 as well. For example, in an embodiment, the external surface of the modifiable structure 110 may be the external surface of the interactive device 102. In another embodiment, the modifiable structure 110 may be contained within a housing of the interactive device 102 and changes to the shape of the modifiable structure 110 may cause corresponding changes to the housing of the interactive 102. In still another embodiment, the interactive device 102 may include a housing with open portions that permit the modifiable structure 110 to be directly interacted with through the open portions of the housing. Further details of the integration of the modifiable structure 110 into the interactive device 102 are provided below.

One or more actuators 120 are disposed within or on a surface of the modifiable structure 110. The actuators 120 may be included within the modifiable structure 110 in any suitable fashion, including by adhesive, mechanical attachments such as screws or staples, welding, bonding, lithography, thin film deposition, 3-D printing, and/or any other method. Methods of coupling between the actuators 120 and the internal structure of the modifiable structure 110 may depend on the specific internal structure of the modifiable structure 110, as described further below with respect to FIGS. 2A-D and 3A-3D. The actuators 120 are configured to generate the compressive or tensile forces within the modifiable structure 110.

One or more sensors 130 are disposed within or on a surface of the modifiable structure 110 and/or within or on other portions of the interactive device 102. The one or more sensors 130 may thus be part of the modifiable structure 110 or part of the interactive device 102. The sensors 130 are configured to detect, determine, or otherwise sense properties of the modifiable structure 110. The sensors 130 may be configured to determine strain, force, and/or displacement of the modifiable structure 110. In such embodiments, the sensors 130 may include strain gauges, piezoelectric sensors, and any other suitable sensor. The sensors 130 may also be configured to determine acceleration or other motion characteristics of the modifiable structure 110. In such embodiments, the sensors 130 may include accelerometers or other suitable motion detection sensors.

One or more circuits 140 are disposed within or on a surface of the modifiable structure 110. The circuits 140 are configured to electrically couple the actuators 120 and/or the sensors 130 to each other and/or to the controller 101, which may be disposed on the modifiable structure 110 or remotely located from the modifiable structure 110. The circuits 140 may be configured to electrically couple the actuators 120, sensors 130, and the controller 101, i.e., the coupled components, in wired or wireless fashion. The circuit 140 may thus include wires and circuit components suitable for facilitating the conduction of signals between the coupled components. Circuit components may include resistors, capacitors, inductors, operational amplifiers, transistors, transformers, and other components that may be required to transfer a signal between the coupled components. In further embodiments, the circuit 140 may include wires, circuit components, and antennas suitable for facilitating the conduction of signals wireless between the coupled components.

The system 100 includes a controller 101. The controller 101 may include one or more processors 210 and one or more non-transient computer memory units 205.

The processors 210 are programmed by one or more computer program instruction stored in the memory unit(s) 205. The one or more processors 210 and the one or more memory units 205 may be referred to herein as simply “the processor 210” and “the memory unit 205,” respectively. The functionality of the processor 210, as described herein, is implemented by software stored in the memory unit(s) 205 or another computer-readable or tangible medium and executed by the processor 210. As used herein, for convenience, the various instructions may be described as performing an operation, when, in fact, the various instructions program the processors 210 to perform the operation. In other embodiments, the functionality of the processor may be performed by hardware (e.g., through the use of an application specific integrated circuit (“ASIC”), a programmable gate array (“PGA”), a field programmable gate array (“FPGA”), etc.), or any combination of hardware and software.

The various instructions described herein may be stored in the memory unit(s) 205, which may include random access memory (RAM), read only memory (ROM), flash memory, and/or any other non-transient computer readable memory suitable for storing software instructions. The memory unit(s) 205 store the computer program instructions (e.g., the aforementioned instructions) to be executed by the processor 210 as well as data that may be manipulated by the processor 210.

The controller 101 is electrically coupled, in wired or wireless fashion, to the actuators 120 of the modifiable structure 110 and the sensors 130 of the interactive device 102. The controller 101, via the processor 210, is configured to control activation of the actuators 120 via an activation control signal transmitted or otherwise sent to the actuators 120 via the circuit 140. The controller 101 is further configured to receive input from the sensors 130, the input from the sensors including information about detected, measured, or otherwise sensed properties of the modifiable structure 110. In some embodiments, the controller 101 is further configured to receive input from the actuators 120. The controller 101 may be configured as a server (e.g., having one or more server blades, processors, etc.), a personal computer (e.g., a desktop computer, a laptop computer, etc.), a smartphone, a tablet computing device, a gaming console, a VR headset, and/or other device that can be programmed to receive and encode haptic effects.

The processor 210 is configured to transmit or send an activation control signal to the interactive device 102 and/or to the one or more actuators 120 of the modifiable structure 110. The activation control signal is configured to cause activation of the actuators 120 to generate internal forces within the modifiable structure 110, as described in greater detail below. The activation control signal is determined by the processor 210 to cause the actuators 120 to generate forces to achieve specific haptic effects on the modifiable structure 110, as described further below. The activation control signal may include multiple signals sent individually to each of a plurality of actuators 120 or a single signal that is routed collectively to all of a plurality of actuators 120. In further embodiments, the processor 210 may send different activation control signals to each of a plurality of actuators 120.

The activation control signal is determined by the processor 210 according to parameters of a software application with which a user of the interactive device 102 is interacting. Interactive devices 102 consistent with embodiments hereof are configured to provide haptic effects to a user through changes or adjustments to a modifiable structure 110 caused by forces generated by the actuators 120. Such haptic effects include, for example, changes in size, resistance or assistance to applied compressive or tensile forces, vibration effects, and/or kinesthetic movement of the interactive device 102, as described in more detail below. The haptic effects are provided to enhance the experience of a user employing the interactive device 102 to interact with a software application, such as a game or productivity application. The processor 210 interacts with a computer system running software applications with which a user is interacting. In embodiments, the processor 210 may be an aspect of the computer system running the software applications with which the user is interacting. The processor 210 generates activation control signals based on processing of one or more software applications with which a user interacts.

In embodiments, the processor 210 may be configured to receive input signals from the sensors 130 and/or the actuators 120 of the modifiable structure 110. Such input signals may be used, in specific embodiments, in addition to or instead of software application parameters for generating activation control signals to provide haptic effects via the interactive device 102. In embodiments, the processor 210 is further configured to generate the activation control signal at least partially in response to data or information provided by the sensors 130 and/or the actuators 120. Sensors 130 may optionally be included in any embodiment of the interactive devices 102 discussed herein. The output of the sensors 130 and/or the actuators 120 may be transmitted to and used by the processor 210 as feedback in a control system, such as a closed loop control system for controlling the actuators 120 of the modifiable structure 110. In further embodiments, sensors located remotely or provided separately from the modifiable structure 110 and the interactive device 102 may be configured to transmit information to the processor 210 for facilitating control of the actuators 120.

In further embodiments, the interactive device 102 includes one or more additional actuator devices and one or more user input elements. Additional actuator devices may be interacted with and activated by the controller 101 to provide the user with further feedback regarding a software application with which the user is interacting. Additional actuator devices may include, for example, linear resonance actuators, eccentric rotating mass actuators, piezoelectric actuators, smart material actuators, electro-active polymer actuators, electrostatic actuators, pneumatic actuators, microfluidic actuators, and any other type of actuator that may be configured to provide haptic feedback. Additional user input elements may include triggers, buttons, joy pads and joy sticks, touch screens, and any other device configured to receive user input.

FIGS. 2A-2D illustrate aspects of a modifiable structure 110 consistent with embodiments hereof. FIG. 2A illustrates the external or macrostructure of the modifiable structure 110, while FIGS. 2B and 2C illustrate progressively zoomed in views of the internal structure or microstructure of the modifiable structure 110. FIG. 2D illustrates an alternate embodiment including electro-active polymer or smart material actuators.

FIGS. 2A-2C illustrate aspects of the modifiable structure 110, including the internal lattice structure 220, the external capsule 260, and the actuators 120. The actuators 120 are disposed within the modifiable structure 110 and are configured to provide a tensile or compressive force to the modifiable structure 110 when activated.

FIG. 2A illustrates an external view of the modifiable structure 110 in an inactive configuration where the actuators 120 are not activated and provide no internal forces. Capsule 260 of the modifiable structure surrounds, encases, encloses, and/or encapsulates the internal lattice structure 220 of the modifiable structure 110.

The lattice structure 220 is the internal structure of the modifiable structure 110 and is configured to mechanically deform to expand or compress according to forces to which it is subject, as explained in greater detail below.

The capsule 260 is configured to surround, enclose, encase, or otherwise encapsulate the hinge elements 250, bridge elements 251, and support elements 252. The capsule 260 forms an exterior of the modifiable structure 110. In embodiments, the capsule 260 may further form an integral part of an interactive device 102 into which the modifiable structure 110 is incorporated. For example, the capsule 260 may form all or a part of the housing of the interactive device 102. The capsule 260 includes an elastic material or composite of materials configured for elastic strain, such as expansion or compression. The capsule material may be an engineered plastic, soft material (rubber, silicone, polyurethane, etc.) and/or a material having a porous micro structure. Accordingly, when subject to tensile or compressive forces the capsule 260 exhibits strain. When tensile or compressive forces are released, such as when the modifiable structure 110 is an inactive configuration, the capsule 260 returns to an initial configuration. The capsule 260 may provide rigidity or may provide flexibility to the modifiable structure 110 when subject to a bending moment, depending on further requirements of the embodiments in which the modifiable structure 110 is employed.

FIG. 2B is an enlarged view of a portion of the lattice structure 220 of the modifiable structure 110 within which a plurality of actuators 120 are arranged, as shown in greater detail in FIG. 2C. The lattice structure 220 includes a plurality of hinge elements 250, a plurality of bridge elements 251, and an optional plurality of support elements 252. The lattice structure 220, including the hinge elements 250, bridge elements 251, and support elements 252, is enclosed or encapsulated by the capsule 260. The bridge elements 251 are arranged in pairs, wherein each pair of bridge elements 251 extends between a pair of hinge elements 250. The hinge elements 250 are configured such that flexure, bending, or other motion of the hinge elements 250 brings the bridge elements 251 closer together or farther apart, depending on the direction of motion of the hinge element 250. Each hinge element 250 includes at least one hinging portion 253 and may include one or more hinging arms 254. The hinging portions 253 connect the hinging arms 254 to each other and/or to the bridge elements 251. The bridge elements 251 and hinge elements 250 are secured within the capsule 260 of the modifiable structure 110 via one or more support elements 252. The support elements 252 which may be coupled to the capsule 260 and to one or more bridge elements 251 and/or hinge elements 250. In some embodiments, the hinge elements 250 and bridge elements 251 are coupled directly to the capsule 260 and no additional support elements 252 are provided.

FIG. 2C is an enlarged view of a single pair of bridge elements 251 shown in FIG. 2B, their corresponding pair of actuators 120, and individual components of one hinge element 250 from the pair of hinge elements 250 associated with the pair of bridge elements 251. The arrows 280 illustrate the direction of motion of the bridge elements 251 and the dotted lines represent an activated configuration to which the bridge elements 251 and hinge elements 250 are capable of moving when the actuators 120 are activated. When the actuators 120 are activated to generate a repulsive force repelling the pair of actuators 120 from each other, the hinging portions 253 of the hinge element 250 enable the movement of the hinge element 250 that permits the bridge elements 251 to move farther apart. When the actuators 120 are activated to generate an attractive force attracting the pair of actuators 120 to each other, the hinging portions 253 of the hinge element 250 enable the movement of the hinge element 250 that permits the bridge elements 251 to move closer together.

In the embodiment of FIG. 2C, each hinge element 250 includes four hinging portions 253A, 253B, 253C, 253D configured to permit relative movement between a plurality of hinging arms 254A, 254B, 254C and bridge elements 251. The hinging portions 253A, 253B, 253C, 253D permit rotational movement of hinging arms 254A and 254C with respect to hinging arm 254B and with respect to bridge elements 251. Thus, each pair of hinge elements 250, located at either end of a pair of bridge elements 251, facilitate the motion of the bridge elements 251.

The precise structure of the hinge elements 250 shown in FIGS. 2A-2C are by way of example only. In further embodiments, hinge elements 250 may include hinging portions 253 that connect only to bridge elements 251 and thus exclude any hinging arms 254. In embodiments, the hinging portions 253 may permit rotational and/or linear movement of the hinging arms 254 or bridge elements 251 coupled thereto. In embodiments, the hinging portions 253 provide rotational movement through deformation of the hinge element 250. The hinging portions 253 are structurally configured to be less rigid than the hinging arms 254, i.e., as living hinges, and therefore will bend more than the hinging arms 254 when subject to forces. In alternative embodiments, the hinging portions 253 of the hinge elements 250 include components configured to rotate relative to one another, and thus the hinge elements 250 do not require strain to permit motion of the bridge elements 251.

The components of the lattice structure 220, e.g., the bridge elements 251, hinge elements 250, and support elements 252 may be formed of any suitable material. For example, the elements may be formed of aluminum, steel, or other metals having suitable properties. These components may also be formed of plastic, carbon fiber, rubber, silicone, polyurethane and/or foam materials. These components may further be formed of composite materials. The lattice structure 220 components may all be formed of a single material or may be formed of diverse materials.

The plurality of hinge elements 250, bridge elements 251, and optional support elements 252 form the lattice structure 220 of the modifiable structure 110. In embodiments, these components are encapsulated by the capsule 260. In embodiments, the capsule 260 may be coupled or attached to any of the component elements of the lattice structure 220 at any point throughout the lattice structure 220. Such coupling may be achieved through adhesives, welding techniques, molding techniques, and other options. The points at which the lattice structure 220 is coupled to the capsule 260 remain in correspondence to one another when the size or shape of the modifiable structure 110 is modified. In further embodiments, the capsule 260 encases the lattice structure 220 but is not coupled to it. In such embodiments, points of the capsule 260 that correspond to points of the lattice structure 220 in an inactive state do not necessarily maintain correspondence when the modifiable structure 110 changes in size or shape.

One or more pairs of the plurality of bridge elements 251 include actuators 120, as shown in FIG. 2C. The actuators 120 are configured such that, in response to an activation signal received via the circuit 140, the actuators 120 generate a force between the two bridge elements 251 of a pair. The force generated between the bridge elements 251 may be an attractive or repulsive force. An attractive force tends to pull the bridge elements 251 closer together while a repulsive force tends to push the bridge elements 251 farther apart.

An attractive force between the bridge elements 251 in response to an activation signal may attract the bridge elements 251 of a pair to one another to provide a variety of haptic effects. As discussed above, the action of the hinge elements 250 permits the bridge elements 251 to move closer together when subject to the attractive force. Movement of a plurality of bridge elements 251 of modifiable structure 110 closer together pulls the capsule 260 with them, when the lattice 220 is attached thereto, and causes the entire modifiable structure 110 to contract, causing a contraction haptic effect. An attractive force between the bridge elements 251 in response to an activation signal may also resist the expansion of the modifiable structure 110, causing a resistance haptic effect. For example, if a user operating the interactive device 102 applies a tensile force to the modifiable structure 110, such force can be resisted by the attractive force between the bridge elements 251. An attractive force between the bridge elements 251 in response to an activation signal may also assist the compression of the modifiable structure 110, causing a haptic assistance effect. An oscillating activation control signal may be applied to the actuators to cause the attractive force to oscillate. An oscillating force causes the lattice structure 220 and thus the capsule 260 to oscillate as well, causing a vibration haptic effect. A kinesthetic haptic effect may be applied via a sharp activation control signal, i.e., an activation control signal configured to cause the modifiable structure 110 to rapidly or sharply contract.

Thus, application of the attractive force to the bridge elements 251 may be used to generate forces within the modifiable structure 110 to provide a user of the interactive device 102 with multiple haptic effects. The user may feel the interactive device 102 pulling inward against their grip, the user may feel the interactive device 102 resisting a force applied by the user, the user may feel the interactive device 102 shrinking in their hands, the user may feel the interactive device 102 vibrating, and/or the user may feel the interactive device 102 contract rapidly. The output haptic effect may be altered according to the amount of attractive force applied to the bridge elements 251 and an amount of force applied by the user.

A repulsive force between the bridge elements 251, generated by the actuators 120 in response to an activation signal, may repel the bridge elements 251 of a pair from one another. As discussed above, the action of the hinge elements 250 permits the bridge elements 251 to move farther apart when subject to the repulsive force. Movement of a plurality of bridge elements 251 of modifiable structure 110 farther apart expands the capsule 260 with them and causes the entire modifiable structure 110 to expand, causing an expansion haptic effect. A repulsive force between the bridge elements 251 in response to an activation signal may also resist the compression of the modifiable structure 110, causing a resistance haptic effect. For example, if a user operating the interactive device 102 applies a compressive force to the modifiable structure 110, such force can be resisted by the repulsive force between the bridge elements 251. A repulsive force between the bridge elements 251 in response to an activation signal may also assist the expansion of the modifiable structure 110, causing a haptic assistance effect. An oscillating activation control signal may be applied to the actuators to cause the repulsive force to oscillate. An oscillating force causes the lattice structure 220 and thus the capsule 260 to oscillate as well, causing a vibration haptic effect. A kinesthetic haptic effect may be applied via a sharp activation control signal, i.e., an activation control signal configured to cause the modifiable structure 110 to rapidly or sharply expand.

Thus, application of the repulsive force to the bridge elements 251 may be used to generate forces within the modifiable structure 110 that provide a user of the interactive device 102 with multiple haptic effects. The user may feel the interactive device 102 pressing outward against their grip, the user may feel the interactive device 102 resisting a force applied by the user, the user may feel the interactive device 102 expanding in their hands, the user may feel the interactive device 102 vibrating, and/or the user may feel the interactive device 102 expand rapidly. The output haptic effect may be altered according to the amount of repulsive force applied to the bridge elements 251 and an amount of force applied by the user.

Repulsive or attractive forces between bridge element 251 pairs may be generated by one or more actuators 120 associated with each bridge element pair 251. Repulsive or attractive forces are generated between the actuators 120, which are disposed on the bridge elements 251. In an embodiment, the actuators 120 are electrostatic actuators, configured in pairs to generate attractive forces or repulsive forces between them. Attractive forces may be generated by electrostatic actuators. Electrostatic actuators include a pair of opposing electrodes that may be activated by an activation control signal to generate attractive or repulsive forces. Each pair of electrostatic actuators creates a layered electrostatic system including three or four layers. The layers include a first electrode and an insulator that make up the first actuator 120 on one of the bridge elements 251 and a second grounding electrode and an insulator that make up the second actuator on the other bridge element 251 of the pair. The electrodes are separated by the insulators. Optionally, only one insulator is included. Optionally, the insulator is air, silicon dioxide, parylene, and/or any other insulator with suitable dielectric strength. The electrostatic actuators may also be formed as a coating of gold, copper, carbon nanotube, graphene, or other suitable material. The thickness of the electrode and insulator layers may vary, for example between several nanometers (e.g., 10 nm) to several micrometers (e.g., 5 μm). The electrode and insulator layers of the actuators may be applied during construction of the lattice 220, for example, through 3-D printing. The actuators 120 may be activated by the activation control signal, received via the circuit 140, to create repulsive or attractive forces between bridge element 251 pairs.

In embodiments, the entire structure of the interactive device 102, including all bridge elements 251, hinge elements 250, support elements 253, capsule 260, and actuators 120 may be constructed through 3-D printing. In further embodiments, the interactive device 102 may be partially constructed through 3-D printing with remaining portions constructed after 3-D printing using additional manufacturing means.

The use of electrostatic actuators as actuators 120 is exemplary only. In further embodiments, the one or more actuators 120 of each bridge element 251 pair may include any type of suitable actuator. For example, the actuators 120 may include one or more electromagnets configured to generate attractive or repulsive forces between the bridge elements 251 when activated. In another example, as shown in FIG. 2D, the actuators 125 may include smart material or electroactive polymer actuators coupled to each bridge element 251 of a pair to bridge the gap between the bridge elements 251. The smart material or electro-active polymer actuators in this embodiment are configured to push or pull the bridge elements 251 farther apart or closer together when actuated.

The sensors 130 of the interactive device 102 may include sensors 130 arranged and/or configured to measure properties of the modifiable structure 110, including mechanical properties of the modifiable structure 110, such as applied force, strain, displacement, etc. The sensors 130 may include any type of sensors suitable for such measurements. For example, the sensors 130 may include strain gauges arranged on the capsule 260 to measure expansion or compression of the capsule 260 in any direction. The sensors 130 may also be arranged within the microstructure of the modifiable structure 110, configured to measure displacement of and/or distance between elements of the microstructure of the modifiable structure 110.

Referring now to FIG. 1 and to FIGS. 2A-2C, in operation, the controller 101, via the processor 205, supplies an activation control signal to one or more of the plurality of actuators 120 to cause the actuators 120 to provide the attractive or repulsive force between the bridge elements 251, thus generating an expansive or compressive force in the modifiable structure 110. The controller 101 is configured to adjust the activation control signal in various ways to provide specific haptic effects as outputs.

In embodiments, the controller 101 may supply the same activation control signal to all of the plurality of actuators 120 of the modifiable structure 110. In further embodiments, the controller 101 may supply one or more different activation control signals to different actuators 120 of the modifiable structure 110. Different actuators 120 may be activated with a different signal, causing them to output different haptic effects. For example, compression or expansion haptic effects may be limited to certain portions of the modifiable structure 110 through activation of only those actuators 120 within that portion. In another example, the magnitude of compression or expansion haptic effects may be modulated according to a number of activated actuators 120.

In embodiments, the controller 101 is configured to apply an activation control signal to the actuators 120 to cause the actuators 120 to generate a force to provide a haptic effect of expansion or compression of the modifiable structure 110. A constant activation control signal causes the actuators 120 to generate an attractive or repulsive force between the actuators 120, resulting in an expansive or compressive force in the modifiable structure 120. The force results in expansion or contraction of the capsule 260 and the entire modifiable structure 110 if no additional force is applied by a user. The magnitude of the force, and thus the amount of expansion or contraction, may be adjusted by increasing or decreasing the magnitude of the activation control signal, and/or by increasing or decreasing the number of actuators 120 activated by the activation control signal. In further embodiments, the controller 101 varies the activation control signal to achieve a specific level of expansion or contraction of the modifiable structure 110. The controller 101 receives input from the sensors 130 to determine the strain (expansive or contractive) of the modifiable structure 110 and to determine an activation control signal configured to increase or decrease the strain to a specific amount. Accordingly, the controller 101 may increase or decrease the activation control signal to counteract any force applied by the user, any force applied by an object in contact with the modifiable structure 110, and/or any force applied by the capsule 260 or supporting elements 252 so as to achieve a specific amount of expansion or contraction.

In embodiments, the controller 101 is configured to apply an activation control signal to the actuators 120 to provide a haptic effect of resistance or assistance to user force. As discussed above, sensors 130 may be employed to determine that a user is applying force, either tensile or compressive, on the modifiable structure 110. In response, the controller 101 may activate the actuators 120 to provide resistance or assistance to the user's force as a haptic effect. In embodiments, the controller 101 may modulate the activation control signal to adjust the force provided by the actuators 120 so as provide an increase (i.e., resistance) or decrease (i.e., assistance) in the apparent stiffness of the modifiable structure 110. Conventionally, stiffness is felt as an increase in resistance with an increase in strain or deformation. Applying an expansive or compressive force to the modifiable structure 110, in the absence of any user applied force, will cause the modifiable structure 110 to expand or contract, respectively. Adjusting the apparent stiffness of the modifiable structure 110 requires continuous adjustment of the activation control signal to increase the resistive or assistive force as the user applies additional strain to the modifiable structure 110. The controller 101 is configured to measure, via the sensors 130, any expansion or contraction of the modifiable structure 110. The controller 101 may use such measurements to determine an appropriate amount of expansive or compressive force to apply to the modifiable structure 110 via the actuators 120 so as not cause expansion or contraction. When a user attempts to apply an expansive or compressive force to the modifiable structure 110, the controller 110 causes the actuators 120 to generate a force resisting or assisting the user applied force such that the user perceives an increase or decrease in stiffness. In embodiments, the opposing force generated by the actuators 120 increases according to the strain applied by the user, allowing the modifiable structure 110 to mimic the feel of a stiffer structure.

In an embodiment, the controller 101 is configured to receive user inputs based on forces, either compressive or tensile, applied to the modifiable structure 110 by a user. In further embodiments, the controller 101 is configured to receive inputs based on shear forces applied by a user. To receive such inputs, the controller 101 is configured to receive inputs from the sensors 130. The received inputs may include strain information indicative of an amount of compressive or tensile strain applied to the modifiable structure 110. The received inputs may further include force information indicative of an amount of compressive or tensile force applied to the modifiable structure 110.

In further embodiments, the controller 101 is configured to cause the output of a haptic effect in the form of a kinesthetic movement of the modifiable structure 110. To cause such outputs, the controller 101 is configured to provide an activation control signal to activate the actuators 120 to generate a force to cause a rapid expansion or contraction of the modifiable structure 110. For example, the activation control signal may be applied to the actuators 120 to cause a single rapid expansion or compression of the capsule 260, providing a popping effect. In another example, application of the activation control signal may be abruptly stopped, eliminating any force provided by the actuators 120, and providing a collapsing or snapping effect. Low frequency kinesthetic movements may also be applied, applying alternative compressive and expansive forces to give the user a feeling akin to a pulse, throb, or wave.

In further embodiments, the controller 101 is configured to cause the output of a haptic effect in the form of a vibration haptic effect. To achieve a vibration haptic effect, the controller 101 is configured to cause the activation of the actuators 120 via an oscillating activation control signal. An oscillating activation control signal supplied to the actuators 120 causes the actuators to generate forces that vibrate the modifiable structure 110 at a frequency consistent with that of the oscillating activation control signal. Provided with an oscillating activation control signal, the modifiable structure 110 may vary between increasing and decreasing expansion or compression or may alter between expansion and compression. The magnitude and frequency of the induced vibrations may be varied by variation of the magnitude and frequency of the activation control signal. In embodiments, an activation control signal having multiple frequencies may be provided by the controller 101 to the actuators 120, thus producing a high definition vibration haptic effect in the modifiable structure 110.

In embodiments, the controller 101 may be configured to activate the actuators 120 with an activation control signal to provide any combination of the above described haptic effects, including expansion or compression, resistance or assistance to force, vibration, and kinesthetic effects simultaneously. For example, the actuators 120 may be activated by a first activation control signal to cause expansion of the interactive device 102. An additional activation control signal may be combined with or overlaid on the first activation control signal to cause the actuators 120 to provide a vibration effect or kinesthetic movement effect in addition to the bending force. Any combination of effects may be provided by the actuators 120.

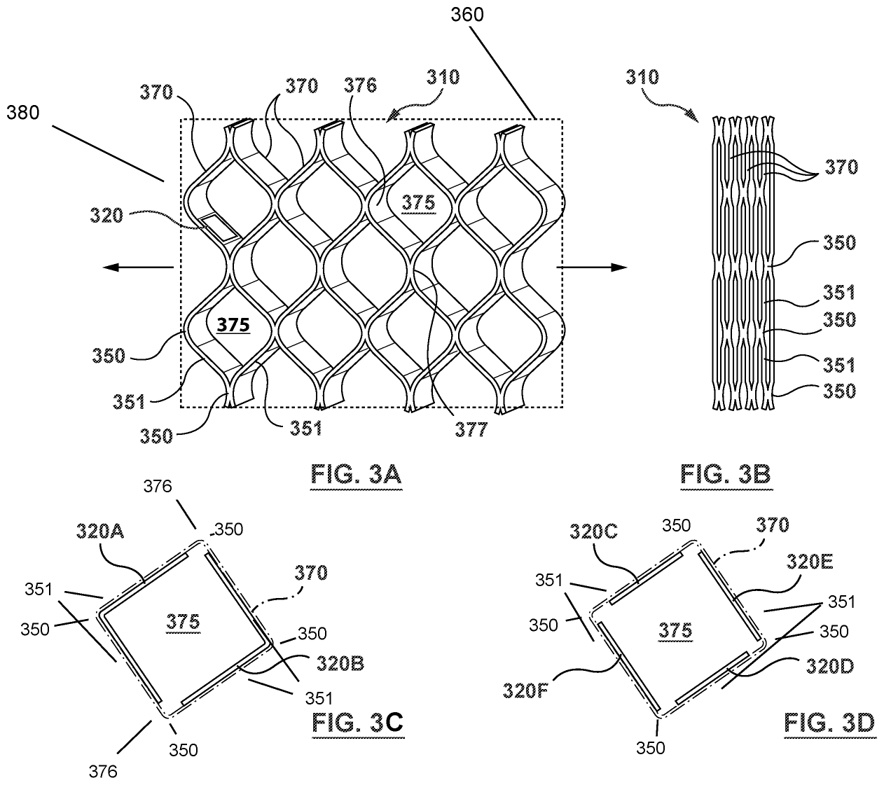

FIGS. 3A-3D illustrate aspects of a modifiable structure 310 consistent with embodiments hereof. FIG. 3A illustrates the modifiable structure 310 in an expanded position while FIG. 3B illustrates the modifiable structure 310 in a collapsed position. In operation, a neutral or inactivated position, e.g., the position maintained by modifiable structure 310 with no active forces applied, may be any position between the expanded position of FIG. 3A and the collapsed position of FIG. 3B, as discussed in greater detail below.

The modifiable structure 310, which may be incorporated into interactive device 102 in place of the modifiable structure 110, includes one or more actuators 320 and one or more layering elements 370 including hinge elements 350 and bridge elements 351 to form lattice 380. The actuators 320 and layering elements 370 are enclosed or encapsulated by a capsule 360. The modifiable structure 310 may optionally include one or more support elements (not shown) coupled to the layering elements 370 to provide additional structural stability. Each layering element 370 includes a plurality of bridge elements 351 and hinge elements 350 forming a single contiguous structure. The hinge elements 350 are arranged between the bridge elements 351 and permit the layering elements 370 to flex or bend at the hinge elements 350 to allow expansion or contraction of the modifiable structure 310. The layering elements 370 are coupled to one or more other layering elements 370 at layer junctions 376, which are formed at hinge elements 350. The bridge elements 351 stretch between pairs of hinge elements 350 to create the lattice 380 within the internal structure of the modifiable structure 310. The bridge elements 351 and hinge elements 350 form the lattice 380 including a plurality of collapsible and expandable boxes 375. Each box 375 includes four bridge elements 351 and four hinge elements 350 and includes portions of two adjacent layering elements 370. The actuators 320 of each box 375 are arranged in pairs on opposing bridge elements 351 and are configured to generate attractive or repulsive forces between each pair.

In an embodiment, as illustrated in FIG. 3C, actuators 320 are arranged in pairs and may extend across two bridge elements 351 and an intervening hinge element 350 located at a layer junction 376 between the bridge elements 351. In such an embodiment, each box 375 includes one pair of actuators 320. The actuators 320A, 320B represent such an embodiment. The actuators 320A, 320B each extend from the hinge element 350 at one layer junction 376 to the hinge element 350 at the opposing layer junction 376, spanning across two bridge elements 351 and the intervening hinge element 350.

In another embodiment, as illustrated in FIG. 3D, actuators 320 may be arranged in pairs and extend across a single bridge element 351 between two hinge elements 350. In this embodiment, each box 375 includes two pairs of actuators 320. The actuators 320C, 320D, 320E, 320F, as illustrated in FIG. 3D, are representative of such an embodiment. Each actuator 320C. 320E has a paired actuator 320D, 320F located on an opposing side of the box 375 and has two non-paired actuators 320 located on adjacent sides of the box 375. As shown in FIG. 3D, the actuator 320C is paired with the actuator 320D, located on an opposing side of the box 375, while the actuator 320E is paired with the actuator 320F, located on an opposing side of the box 375.

Activation control signals received by the actuators 320 from the controller 101 are configured to generate attractive or repulsive forces between opposing actuator 320 pairs. The controller 101 may be configured to apply activation control signals to modifiable structure 310 to achieve any or all of the haptic effects discussed above with respect to modifiable structure 110.

FIG. 2A-2C and FIGS. 3A-3D illustrate embodiments of a modifiable structure wherein attractive and repulsive forces between the incorporated actuators generate compressive and tensile forces, respectively. In alternative embodiments, actuators may be incorporated into modifiable structures such that attractive forces between the actuators generate tensile force and repulsive forces generate compressive force. For example, hinge elements and bridge elements may be arranged such that movement of bridge elements away from each other in a first dimension causes the microstructure to compress in a second dimension. The second dimension may be perpendicular to the first dimension. Thus, repulsive forces generated by actuators between the bridge elements serves to create compression in a direction perpendicular to that of the repulsive forces and attractive forces generated by actuators between the bridge elements serves to create tensile forces in a direction perpendicular to that of the attractive forces.

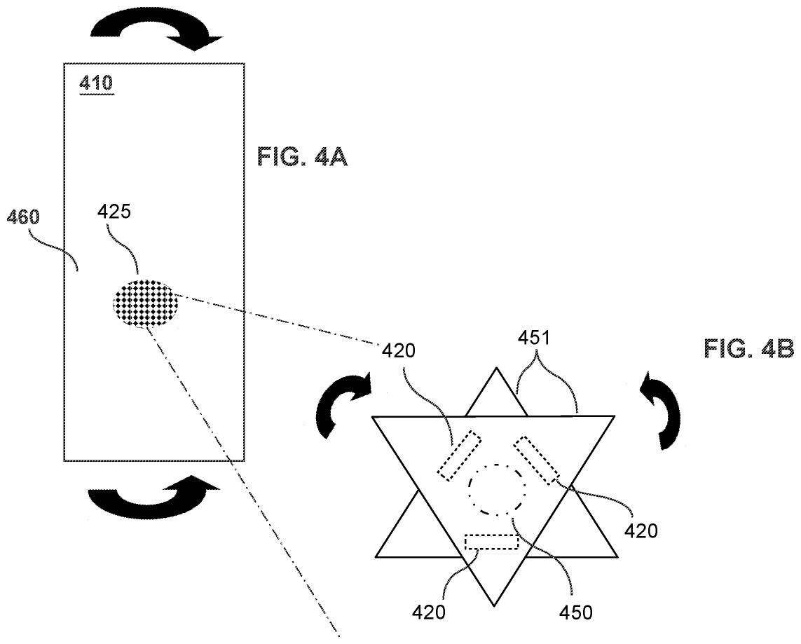

FIGS. 4A-4B illustrate a modifiable structure 410 configured to generate shear or torsional forces within the modifiable structure. The generated shear or torsional forces may be employed to create bending or twisting effects in an interactive device incorporating the modifiable structure 410, to resist or assist a user in creating bending or twisting effects, to create vibration effects, and/or to create kinesthetic effects. The modifiable structure 410 includes a capsule 460 surrounding or encapsulating a lattice structure 425. The lattice structure 425 represents the microstructure of the modifiable structure 410. The capsule 460 may include any or all of the features and characteristics of the capsule 160, as previously described with respect to FIGS. 2A-2C. The lattice structure 425 includes bridge elements 451, hinge elements 450, and one or more actuators 420. In some embodiments, the lattice structure 425 may further include support elements (not shown) providing additional structural support to the bridge elements 451 and hinge elements 450.

Each bridge element 451 is paired with at least one corresponding bridge element 451. The bridge elements 451 are connected to their corresponding bridge elements 451 via at least one hinge element 450. The hinge elements 450 are configured to permit each bridge element 451 to rotate with respect to its corresponding bridge element 451. When the modifiable structure 410 is bent or twisted, these strains are imposed on the lattice structure 425. When strained through bending or twisting, the bridge elements 451, enabled by the hinge elements 450, rotate with respect to their corresponding bridge elements 451.

Each pair of corresponding bridge elements 451 includes one or more actuators 420 disposed thereon. The actuators 420 are configured to apply forces clockwise or counterclockwise forces to the bridge elements 451 to create twisting or bending in the lattice structure 425 or to resist or assist twisting or bending in the lattice structure 425. The clockwise and/or counterclockwise forces may be generated, for example, by attractive and/or repulsive forces between the actuators 120 disposed on corresponding bridge elements 451. In further embodiments, the clockwise or counterclockwise forces of the actuators 420 may generate vibration effects through oscillating application of forces and/or may generate kinesthetic effects through the sharp or rapid application of the forces. The actuators 420 may include electrostatic actuators, electro-active polymer actuators, smart material actuators, piezo electric actuators, shape memory material actuators, and/or any other suitable actuator. The actuators 420 bridge elements 451, hinge elements 450, support elements, and capsule 460 may be substantially flat structural elements and/or may include or be constructed according to any of the features or characteristics as described above with respect to the bridge elements 251, hinge elements 250, support elements 252, capsule 260, and actuators 120. Although the bridge elements 451 and the hinge elements 450 are illustrated as triangle shaped and circle shaped respectively, the embodiment is not limited to these form factors. Any suitable shape, including squares, circles, etc., may be employed by the bridge elements 451 and hinge elements 450.

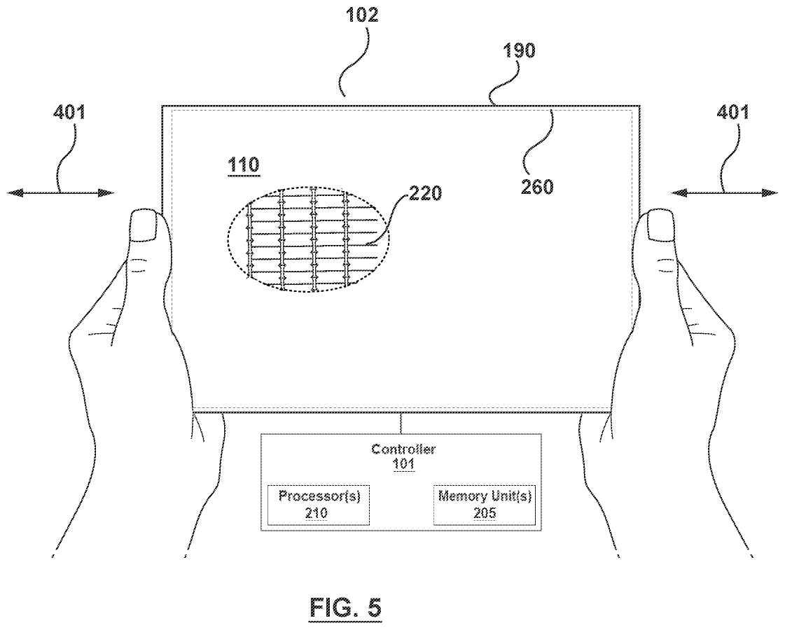

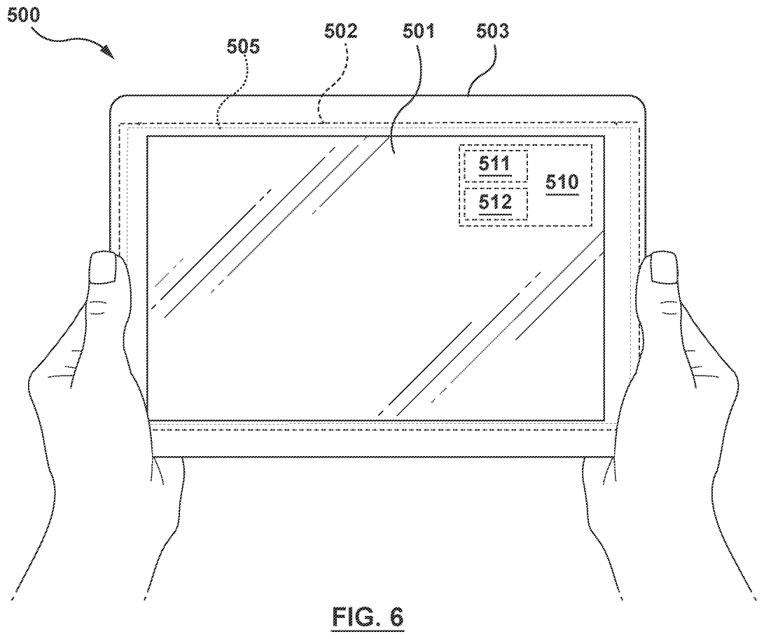

FIG. 5 illustrates use of the interactive device 102, incorporating the modifiable structure 110, as a user interactive input/output device. In an embodiment, as illustrated in FIG. 5 the interactive device 102 includes a flexible housing 190 configured to deform in compression or tension according to the deformations of the modifiable structure 110 caused by expansion or contraction of the lattice structure 220. In alternative embodiments, the interactive device 102 does not include an additional housing, and the external surface of the modifiable structure 110, e.g., the capsule 260, is also the external surface of the interactive device 102. In alternative embodiments (not shown), the interactive device 102 includes a rigid housing with openings to permit the user to interact with the modifiable structure 110 and/or flexible portions through which the user can interact with the modifiable structure 110. Although discussed with respect to the modifiable structure 110, the modifiable structure 310, modifiable structure 410, or any other suitable modifiable structure described herein may be employed with this embodiment.

The controller 101 selectively activates the actuators 120 to adjust the forces applied to the modifiable structure 110 to provide haptic effects to the user in the form of expansion/contraction effects, resistance/assistance effects, vibration effects, and kinesthetic effects. The user, holding the interactive device 102 in one hand or two, feels the haptic effects of the interactive device 102 as caused by the actuator generated forces of the modifiable structure 110, and provides input to the interactive device 102 through pressure or force applied in tension or compression to the interactive device 102. The directional movement of the interactive device 102 in providing haptic effects or receiving user inputs is illustrated by the arrows 401. The user may also provide shear forces as inputs. The haptic effects may be provided according to actions occurring in a software application operating on the interactive device 102 and may therefore convey information to the user.

In embodiments, the interactive device 102 is configured to receive input forces from the user. The user may apply forces, compressive or tensile, in either direction of the arrows 401 as an input to a software application. The user may also apply shear forces as input to a software application. The user may also apply compressive or tensile forces to the interactive device 102 in any other direction, including directions transverse to the arrows 401 and directions diagonal to the arrows 401, for instance. Such forces may be measured by the one or more sensors 130 of the interactive device 102 and transmitted to the controller 101. The controller 101 may receive the applied forces as a user input to a software application.

The above discussion of controller 101 makes reference to compressive and tensile forces applied to and produced by an interactive device 102 incorporating a modifiable structure such as modifiable structure 110. In further embodiments, the controller 101 may be configured to control and operate an interactive device 102 incorporating the modifiable structure 420, which is configured to produce haptic effects and to receive inputs through bending and twisting forces. In such an embodiment, the controller 101 operates generally the same fashion as described above.

FIG. 6 illustrates a user display device 500 incorporating an interactive device 502 according to embodiments. The user display device 500 incorporates at least a display screen 501, a housing 503, and an interactive device 502. The interactive device 502 may be or may include all of the same components and functionality as described herein with respect to interactive device 102, including a modifiable structure 505 consistent with the modifiable structures 110, 310, 410, and any other variations disclosed herein. The user display device 500 may be configured as a smartphone, tablet, phablet, laptop computer, television, gaming controller, and/or any other type of user device including a display screen 501. The display screen 501 is configured to provide a visual display to the user. The user display device 500 may further include devices with flexible screens specifically designed for use with the interactive device 502. The user display device 500 further includes a controller 510 including a processor 511 and a memory unit 512 and additional components necessary to operate as a user device. The controller 510 may be or may include all of the same components and functionality of controller 101. The user display device 500 is configured to run software applications, display and output multi-media files, perform communication tasks, and perform all other tasks typical of such devices.

In embodiments, the display screen 501 and the housing 503 are flexible, configured to expand or contract when subject to tensile or compressive forces applied by a user. The display screen 501 may be a touch or pressure sensitive display screen, and the housing 503 may include one or more user input buttons, pads, sensors, etc. The interactive device 502 of the user display device 500 provides haptic effects to the user display device 500 through structural modifications of the modifiable structure 505. The flexible display screen 501 and the flexible housing 503 permit the user display device 500 to expand or contract when subject to forces provided by the modifiable structure 505. The modifiable structure 505 of the interactive device 502, when activated via an activation control signal, causes the user display device 500 to output haptic effects including expansion/contraction effects, resistance/assistance effects, vibration effects, and kinesthetic effects. In further embodiments, as discussed above, the interactive device 502 may act to receive inputs from a user in the form of user applied force or strain, either tensile or compressive.

For example, the user display device 500 may be configured to provide any haptic effect of the interactive device 102 to a user related to operation of the user display device 500. The user may also provide input via the application of tensile and/or compressive force, which may be counteracted or resisted by structural modifications induced by actuators of the modifiable structure 505. Applied force inputs can be quantified by direction of force, magnitude of force applied, and speed of force application. Such inputs may be used by a software application, for example, to scroll through a list, adjust a volume level, scrub through a video, where the speed or location in the list, level or video may be adjusted based on a magnitude of the force applied. In other embodiments, a quick or rapid squeezing or stretching movement may be interpreted as a button press or click. The interactive device 502 employed with the user display device 500 may have a modifiable structure 505 according to that of modifiable structure 110, modifiable structure 310, modifiable structure 410, and/or any other suitable modifiable structure. When configured to incorporate the modifiable structure 410, the interactive device 502 is configured to produce haptic effects related to twisting and bending forces, rather than compressive and tensile forces. The interactive device 502 employed with the user display device 500 may be configured to receive applied force inputs along any dimension, as implemented by one or more sensors disposed within or on the interactive device 502.

Use of applied force inputs may be advantageous because they do not require a user to reposition their hands to provide input. A common position for use of a user display device 500 requires the user's hands to be placed on either side of the device with both thumbs on the display side of the device and the fingers curling behind the device. This position permits a maximum amount of screen real estate to be visible to a user. In such a position, inputs may be limited according to the range of motion of the user's thumbs and moving one hand to use a finger or thumb on the screen serves to obscure the user's view. The addition of applied force inputs, such as stretching and squeezing, permits the user a wider range of interactive possibilities and mechanics for interacting with any type of software application that is in operation on the user display device 500.

All previously described features of the interactive device 102 may be employed within the context of a user display device 500. In further embodiments of a user display device 500, the housing 503 is either optional and/or minimal in nature. That is, the user display device 500 may include a display 501 bonded or otherwise attached to an interactive device 102 with only minimal additional structural elements.

Integration with the user display device 500 represents an example usage of the interactive devices described herein. The interactive devices described herein are not, however, limited to such user display devices and may be employed as or part of an interactive user device in any appropriate further embodiment without departing from the scope of the invention.

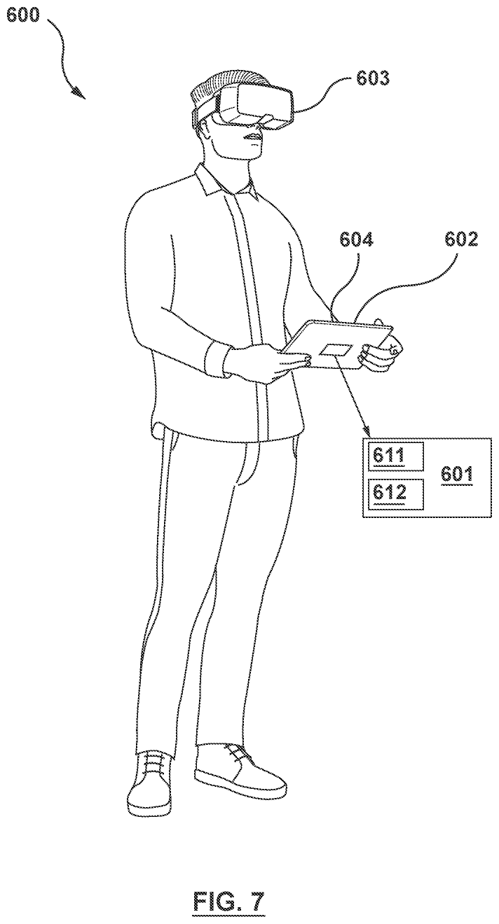

FIG. 7 illustrates an immersive reality system 600 incorporating an interactive device 602, controller 601, and immersive reality display device 603. The interactive device 602 includes all of the features and functionality of the interactive devices 102 and 502. The interactive device 602 optionally further includes a touch-sensitive surface 604. The interactive device 602 may include any of the modifiable structures discussed herein, including modifiable structures 110, 310 and 410 to provide haptic effects based on compressive and tensile forces or bending and twisting forces generated by actuators of the modifiable structures, as discussed above.

The controller 601, including processor 611 and memory unit 612, includes all of the functionality described with respect to controller 101 and additional features and functionality as required to operate within the immersive reality system 600. The immersive reality display device 603 is a display device configured to provide a user with an immersive reality display. The immersive reality display device 603 may be a head mounted display, goggles, glasses, contact lens, helmet, projection device, and/or a device configured to project images to a user's retina.

A display screen is optional but not required in interactive device 602 because the immersive reality display device 603 may provide all of the display requirements for the immersive reality system 600. In augmented or mixed reality versions of the immersive reality system 600, the immersive reality display device 603 may permit the user to continue viewing aspects of the real world. In such embodiments, including a display screen in the interactive device 602 may be advantageous. In fully immersive embodiments of the immersive reality system 600 that do not permit a user to see any aspects of the real world, a display screen on the interactive device 602 may still be implemented, for example, to facilitate control of the system 600 when the immersive reality display device 603 is not worn and/or to provide interaction with nearby people that cannot interact directly with the immersive environment of the immersive reality system 600.

In embodiments, the immersive reality display system 600 includes additional sensors to detect, identify, or otherwise sense user input. The sensors may be configured to detect position, location, and/or movement (i.e., displacement, vibration, acceleration, etc.) of the interactive device 602. The sensors may further be configured to detect or identify the motion, position, location, and/or movement of a user's hands or figures with respect to the interactive device 602. For example, sensors configured to detect movement aspects of the interactive device 602 may include accelerometers or other sensors mounted on the interactive device 602 and may also include non-contact based motion sensors, such as cameras, lasers, or other sensors that can detect properties of the interactive device 602 remotely. Other sensors may include devices configured to detect movement of the user's fingers or hands. Such sensors may be incorporated in wearable devices, for example, and may also include non-contact sensors, such as cameras, lasers, and others.

The information determined by the sensor may be used as input to the immersive reality system 600 and any immersive reality applications or operations provided by the immersive reality system 600. In an embodiment, the immersive reality display device 603 provides a user with an augmented or fully immersive display that causes the user to see a virtual display on the interactive device 602. The user may interact with the virtual display on the interactive device 602, for example, by drawing, clicking, writing, etc., and the user's movements may be detected by the sensors as input to the immersive reality system 600. Thus, even though, in this embodiment, the interactive device 602 lacks a touchscreen or display, the user may still interact with it as if it includes both.

In embodiments, structural modifications to interactive devices may be used in both abstract and simulative interactions in both immersive and non-immersive environments. In interactions with an application, the interactive devices may deliver haptic effects to and receive inputs from a user in a non-simulative, abstract fashion. For example, the user may bend or twist the interactive device to scroll through a list, adjust volume, scrub through a video, select a menu option, and provide any other input to the application. Similarly, abstract haptic effects may be provided that correspond to actions within the application. In simulative interactions with an application, interactive devices may receive input and provide haptic effects to simulate a specific interaction within an application. For example, if a user interacts with an object in an immersive environment, the interactive device may serve as a real-world proxy for the virtual object. The characteristics of the interactive device may be adjusted to correspond to characteristics of the virtual object, e.g., the stiffness of the interactive device may be adjusted according to whether the virtual object is flexible such as rubber or stiff such as a stiff plastic or metal, the interactive device may simulate a fish by wiggling in the user's grasp, and/or the interactive device may simulate an object such as a bow in an archery game. The above examples are merely illustrative, and interactive devices consistent with embodiments hereof may be operated with many other abstract and simulative mechanics and uses.

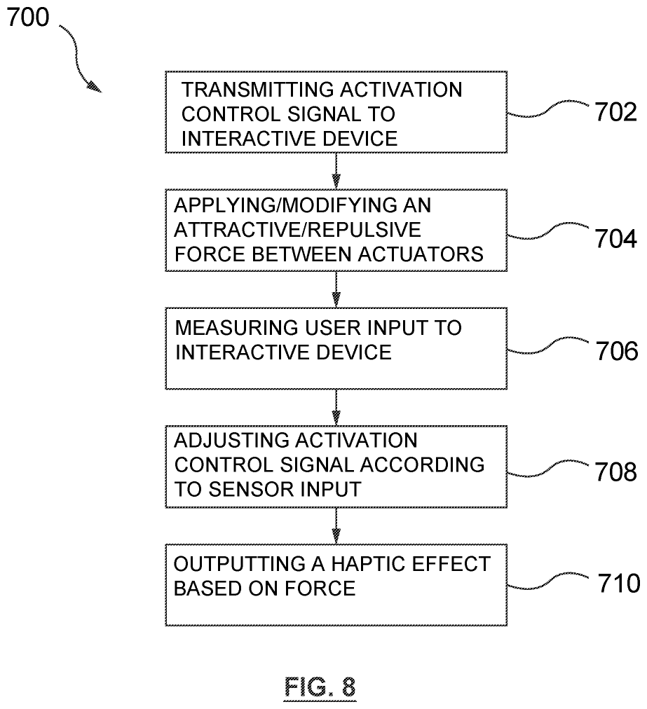

FIG. 8 is a flow diagram illustrating a structural modification process 700 of modifying the structure of an interactive device to produce haptic effects. The process 700 may be performed via any of the interactive devices 102, 502, 602 described herein, including any of the modifiable structures 110, 310, 410 discussed herein and associated components described herein using any combination of features, as may be required for the various operations of the process. The interactive devices suitable for the process 700 include those in which a modifiable structure is encased or enclosed in a housing. The structural modification process 700 may be carried out with more or fewer of the described operations, in any order.

In an operation 702, the structural modification process 700 includes transmitting an activation control signal to an interactive device. A processor or processors associated with a controller of the interactive device generates and transmits, via appropriate circuitry, one or more activation control signals to the interactive device. The activation control signal may include multiple activation control signals sent by the processor and received by each actuator of the interactive device individually and/or may be a single activation control signal sent by the processor and routed to the individual actuators of the interactive device. Multiple activation control signals may differ from one another to cause different output forces at different actuators. The activation control signal or signals determined by the processor are generated by the controller to cause a specific haptic effect, e.g., to output an expansion/contraction effect, a twisting/bending effect, a resistance/assistance effect, a vibration haptic effect, and/or a kinesthetic movement effect. Activation control signals may also be configured to provide a combination of multiple effects, such as inducing both expansion and vibration.

In an operation 704, the structural modification process 700 includes applying or modifying an attractive or repulsive force between actuators of the interactive device. The actuators are activated by the activation control signal to apply or modify the attractive or repulsive force between them. The magnitude of the attractive or repulsive force depends on characteristics of the activation control signal, including, for example, the amplitude of the activation control signal.

In an operation 706, the structural modification process 700 optionally includes measuring a user input to the interactive device. Specifically, the sensors, including, for example, strain gauges, force sensors, etc., detect, determine, or otherwise measure deformation and/or force applied to the interactive device. Deformation of the interactive device may include a tensile strain or a compressive strain, applied in any dimension of the interactive device. Force applied to the interactive device may include tensile, compressive, and/or shear forces, applied in any dimension of the interactive device. The user input, as determined by the one or more sensors, may be transmitted or otherwise sent to the processor via the circuitry for interpretation, analysis, and control. After appropriate interpretation, the processor may then send information about the detected user input to a software application with which the user is interacting.

In some embodiments, the processor is configured to differentiate between structural modifications caused by action of the actuators and structural modifications occurring due to user input. Such differentiation may be performed, for example, by comparing the expected deformation or force in the modifiable structure according to an activation control signal supplied by the controller to the deformation or force that is detected by the one or more sensors.

In an operation 708, the structural modification process 700 optionally includes adjusting the activation control signal according to sensor input indicative of a deformation or force applied to the interactive device. The processor, which may receive input about deformation or strain and/or force applied to the modifiable structure of the interactive device, from the one or more sensors, is configured to use the input to adjust the activation control signal. The processor can continuously adjust the activation control signal of the actuators in the modifiable structure according to the deformation or force applied to achieve a desired expansion or contraction, twisting or bending. The applied force or deformation may be applied by the actuators of the interactive device, by an interacting user, by a case or enclosure of the interactive device, and/or by any other external force. The processor can also continuously adjust the activation control signal of the modifiable structure according to the deformation or force applied to achieve a desired apparent stiffness, as discussed above. The processor may thus adjust the activation control signal in a closed loop fashion.

In an operation 710, the structural modification process 700 includes outputting a haptic effect based on the forces generated by the actuators. The change in forces in the internal structure of the interactive device induced by the actuators causes the output of haptic effects, as discussed above. The actuators are configured to apply an attractive force tending to compress the interactive device and/or to apply a repulsive force tending to expand the interactive device. These forces may be applied to alter the shape and size of the interactive device. When applied in reaction to a force provided by a user, the attractive and repulsive forces may be adjusted by the controller to adjust the apparent stiffness of the interactive device. The attractive and repulsive forces may also be applied to cause the generation of vibration haptic effects and kinesthetic movement effects. In further embodiments, the output haptic effects may further include bending and twisting effects caused by attraction and/or repulsion between the actuators.

In further embodiments, the processor may adjust the control signal in an open loop fashion, according to determined correlations between activation control signals and structural changes of the modifiable structure. The memory unit of the controller may store a look up table or other data store containing correlation information between activation control signals and the estimated resulting haptic effects. Accordingly, even without closed loop control, the controller may function accurately to provide the appropriate amount of force to induce a specific haptic effect.

The above describes an illustrative flow of an example process 700 of modifying the structure of an interactive device to provide haptic effects and receive user inputs. The process as illustrated in FIG. 8 is exemplary only, and variations exist without departing from the scope of the embodiments disclosed herein. The steps may be performed in a different order than that described, additional steps may be performed, and/or fewer steps may be performed.

Additional embodiments are described below.

Embodiment 1 is an interactive device, comprising a modifiable structure configured for structural modification in response to an activation control signal. The modifiable structure includes a pair of bridge elements, wherein the pair of bridge elements extends between a pair of hinge elements, a pair of actuators disposed on the pair of bridge elements; and a circuit configured to deliver an activation control signal to the pair of actuators. The pair of actuators generates a force between the pair of bridge elements in response to the activation control signal, the force causing the modifiable structure to output a haptic effect.

Embodiment 2 is the interactive device of embodiment 1, wherein the force generated between the pair of bridge elements is an electrostatic force.

Embodiment 3 is the interactive device of embodiments 1 or 2, wherein the force is an attractive force between the pair of bridge elements.

Embodiment 4 is the interactive device of any of embodiments 1 to 3, wherein the attractive force causes the haptic effect to be output as a compression of the modifiable structure.

Embodiment 5 is the interactive device of any of embodiments 1 to 4, wherein the attractive force causes the haptic effect to be output as a resistance to an external tensile force on the modifiable structure.

Embodiment 6 is the interactive device of any of embodiments 1 to 5, wherein the force is a repulsive force between the pair of bridge elements.

Embodiment 7 is the interactive device of any of embodiments 1 to 6 wherein the repulsive force causes the haptic effect to be output as an expansion of the modifiable structure.

Embodiment 8 is the interactive device of any of embodiments 1 to 7, wherein the repulsive force causes the haptic effect to be output as a resistance to an external compressive force on the modifiable structure.

Embodiment 9 is the interactive device of any of embodiments 1 to 8, further comprising at least one sensor configured to detect a user input provided via at least one of a compressive force and a tensile force applied to the interactive device.

Embodiment 10 is the interactive device of any of embodiments 1 to 9, further comprising at least one processor configured to determine the activation control signal according to a software application.

Embodiment 11 is a method of modifying the structure of an interactive device to produce a haptic effect. The method includes providing an activation control signal to a pair of actuators disposed on a pair of bridge elements of a modifiable structure of the interactive device, wherein the bridge elements extend between a pair of hinge elements; generating a force between the pair of bridge elements by the pair of actuators in response to the activation control signal; and outputting a haptic effect based on the force.

Embodiment 12 is the method of embodiment 11, wherein generating the force between the pair of bridge elements includes generating an electrostatic force.

Embodiment 13 is the method of embodiment 11 or 12, wherein generating the force between the pair of bridge elements includes generating an attractive force.

Embodiment 14 is the method of any of embodiments 11 to 13, further comprising outputting the haptic effect as a compression of the modifiable structure.

Embodiment 15 is the method of any of embodiments 11 to 14, further comprising outputting the haptic effect as a resistance to an external tensile force applied to the modifiable structure.

Embodiment 16 is the method of any of embodiments 11 to 15, wherein generating the force between the pair of bridge elements includes generating a repulsive force.

Embodiment 17 is the method of any of embodiments 11 to 16, further comprising outputting the haptic effect as an expansion of the modifiable structure.

Embodiment 18 is the method of any of embodiments 11 to 17, further comprising outputting the haptic effect as a resistance to a compressive force applied to the modifiable structure.

Embodiment 19 is the method of any of embodiments 11 to 18, further comprising receiving a user input detected by at least one sensor according to a detection of at least one of a compressive force and a tensile force applied to the interactive device.

Embodiment 20 is the method of any of embodiments 11 to 19, further comprising determining the activation control signal, by a processor, according to a software application.

Thus, there are provided systems, devices, and methods for modifying the structure of an interactive device to produce haptic effects and to receive user inputs. While various embodiments according to the present invention have been described above, it should be understood that they have been presented by way of illustration and example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments but should be defined only in accordance with the appended claims and their equivalents. It will also be understood that each feature of each embodiment discussed herein, and of each reference cited herein, can be used in combination with the features of any other embodiment. Aspects of the above methods of generating kinesthetic effects may be used in any combination with other methods described herein or the methods can be used separately. All patents and publications discussed herein are incorporated by reference herein in their entirety.

What is claimed is:

1. An interactive device, comprising:
a modifiable structure configured for structural modification in response to an activation control signal, the modifiable structure including
a pair of bridge elements, wherein the pair of bridge elements extends between a pair of hinge elements, and
a pair of actuators disposed on the pair of bridge elements; and
a circuit configured to deliver an activation control signal to the pair of actuators,
wherein the pair of actuators generates a force between the pair of bridge elements in response to the activation control signal, the force causing the modifiable structure to output a haptic effect.

2. The interactive device of claim 1, wherein the force generated between the pair of bridge elements is an electrostatic force.

3. The interactive device of claim 1, wherein the force is an attractive force between the pair of bridge elements.

4. The interactive device of claim 3, wherein the attractive force causes the haptic effect to be output as a compression of the modifiable structure.

5. The interactive device of claim 3, wherein the attractive force causes the haptic effect to be output as a resistance to an external tensile force on the modifiable structure.

6. The interactive device of claim 1, wherein the force is a repulsive force between the pair of bridge elements.

7. The interactive device of claim 6, wherein the repulsive force causes the haptic effect to be output as an expansion of the modifiable structure.

8. The interactive device of claim 6, wherein the repulsive force causes the haptic effect to be output as a resistance to an external compressive force on the modifiable structure.

9. The interactive device of claim 1, further comprising at least one sensor configured to detect a user input provided via at least one of a compressive force and a tensile force applied to the interactive device.

10. The interactive device of claim 1, further comprising at least one processor configured to determine the activation control signal according to a software application.

11. A method of modifying the structure of an interactive device to produce a haptic effect, comprising:
providing an activation control signal to a pair of actuators disposed on a pair of bridge elements of a modifiable structure of the interactive device, wherein the bridge elements extend between a pair of hinge elements;
generating a force between the pair of bridge elements by the pair of actuators in response to the activation control signal; and
outputting a haptic effect based on the force.

12. The method of claim 11, wherein generating the force between the pair of bridge elements includes generating an electrostatic force.

13. The method of claim 11, wherein generating the force between the pair of bridge elements includes generating an attractive force.

14. The method of claim 13, further comprising outputting the haptic effect as a compression of the modifiable structure.

15. The method of claim 13, further comprising outputting the haptic effect as a resistance to an external tensile force applied to the modifiable structure.

16. The method of claim 11, wherein generating the force between the pair of bridge elements includes generating a repulsive force.

17. The method of claim 16, further comprising outputting the haptic effect as an expansion of the modifiable structure.

18. The method of claim 16, further comprising outputting the haptic effect as a resistance to a compressive force applied to the modifiable structure.

19. The method of claim 11, further comprising receiving a user input detected by at least one sensor according to a detection of at least one of a compressive force and a tensile force applied to the interactive device.

20. The method of claim 11, further comprising determining the activation control signal, by a processor, according to a software application.
